(19) United States
(12) Patent Application Publication
(10) Pub. No.: US 2006/0288825 A1
(43) Pub. Date: Dec. 28, 2006

(54) WRENCH ASSEMBLY

(76) Inventor: Bobby Hu, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/279,650

(22) Filed: Apr. 13, 2006

(30) Foreign Application Priority Data
Jun. 24, 2005 (TW) 94121298

(51) Int. Cl. B25B 23/16; B25G 1/04

(52) U.S. Cl. 81/177.2

(57) ABSTRACT

A wrench assembly includes a first wrench, a second wrench and a bar. The first wrench includes a first driving device at an end and a second driving device at an opposite end. The second wrench includes a first driving device at an end and a second driving device at an opposite end. The bar includes a first connecting device for connection to the second driving device of the first wrench and a second connecting device for connection to the first driving device of the second wrench. The first C-clip reinforces the connection of the first connecting device of the bar to the second driving device of the first wrench. The second C-clip reinforces the connection of the second connecting device of the bar to the first driving device of the second wrench.

### BACKGROUND OF INVENTION

1. Field of Invention

The present invention relates to a wrench assembly.

2. RELATED PRIOR ART

Disclosed in U.S. Pat. No. 3,376,768 is a linkage bar 1 for wrenches 15 and 16. The bar 1 is formed with two ends 2 and 3 and two surfaces 4 and 5. The bar 1 includes two studs 6 and 7 on the surface 4 near the ends 2 and 3, respectively. The bar 1 includes two studs 8 and 9 on the surface 5 near the ends 2 and 3, respectively. The studs 6 and 7 can fit in box ends of wrenches. The studs 8 and 9 can be fit in the open ends of the wrenches 15 and 16. The studs 6 through 9 must be high enough and the ends of the wrenches 15 and 16 must be thick enough to provide adequate engagement of the bar 1 with the wrenches 15 and 16. Such large dimensions however make it difficult to use the bar 1 and the wrenches 15 and 16 within limited space.

Disclosed in U.S. Pat. No. 5,996,448 is a socket wrench including a handle 2, extension means 20 and a ratchet head 30. The extension means 20 includes receiving means 22 for receiving a shank 8 of the handle 2 and a shank 24 for insertion in receiving means 32 of the ratchet head 30. The shank 24 is equipped with a spring-loaded detent for abutting an internal face of the receiving means 32. The shank 8 is equipped with a spring-loaded detent for abutting an internal face of the receiving means 22. However, the detents cannot adequately retain the shank 24 within the receiving means 32 and the shank 8 within the receiving means 22. As compensation, the shanks 24 and 8 must be high enough and the receiving means 32 and 22 must be thick enough. Such large dimensions however make it difficult to use the wrench within limited space.

The present invention is therefore intended to obviate or at least alleviate the problems encountered in prior art.

### SUMMARY OF INVENTION

According to the present invention, a wrench assembly includes a first wrench, a second wrench and a bar. The first wrench includes a first driving device at an end and a second driving device at an opposite end. The second wrench includes a first driving device at an end and a second driving device at an opposite end. The bar includes a first connecting device for connection to the second driving device of the first wrench and a second connecting device for connection to the first driving device of the second wrench. The first C-clip reinforces the connection of the first connecting device of the bar to the second driving device of the first wrench. The second C-clip reinforces the connection of the second connecting device of the bar to the first driving device of the second wrench.

An advantage of the wrench assembly of the present invention is that the C-clips ensure adequate connection of the first and second wrenches to the bar.

An advantage of the wrench assembly of the present invention is that the first and second wrenches and the bar are thin and easily operable within limited space since the interconnection is ensured.

Other advantages and features of the present invention will become apparent from the following description referring to the drawings.

### BRIEF DESCRIPTION OF DRAWINGS

The present invention will be described through detailed illustration of four embodiments referring to the drawings.

FIG. 1 is a perspective view of a wrench assembly according to the first embodiment of the present invention.

FIG. 2 is an exploded view of the wrench assembly shown in FIG. 1.

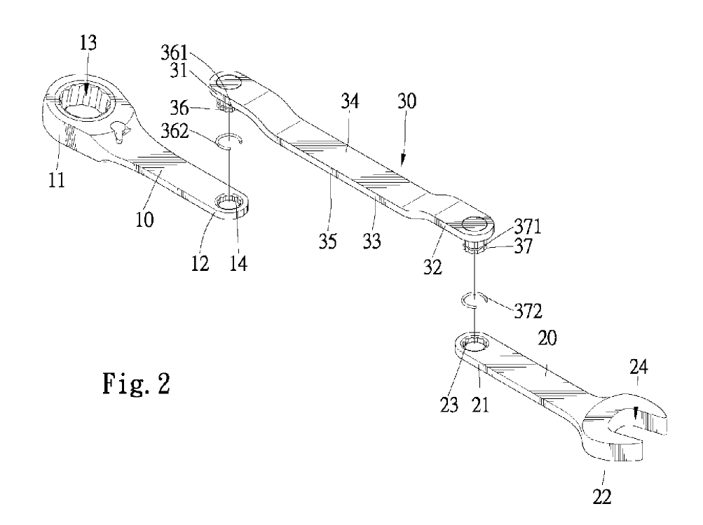

FIG. 3 is a side view of the wrench assembly shown in FIG. 1.

FIG. 4 is an enlarged partial cross-sectional view of the wrench assembly shown in FIG. 3.

FIG. 5 is an exploded view of a wrench assembly according to the second embodiment of the present invention.

FIG. 6 is a side view of the wrench assembly shown in FIG. 5.

FIG. 7 is an enlarged partial cross-sectional view of the wrench assembly shown in FIG. 6.

FIG. 8 is an exploded view of a wrench assembly according to the third embodiment of the present invention.

FIG. 9 is a side view of the wrench assembly shown in FIG. 8.

FIG. 10 is an exploded view of a wrench assembly according to the fourth embodiment of the present invention.

FIG. 11 is a side view of the wrench assembly shown in FIG. 10.

### DETAILED DESCRIPTION OF EMBODIMENTS

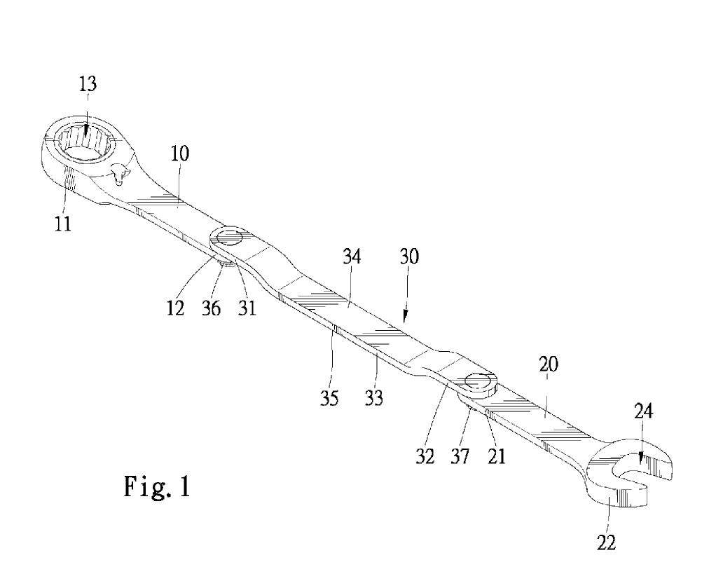

Referring to FIG. 1, there is shown a wrench assembly according to a first embodiment of the present invention. The assembly includes a first wrench 10, a second wrench 20 and a bar 30.

The first wrench 10 includes a first driving device 13 provided at a first end 11 and a second driving device 14 formed at a second end 12. The first driving device 13 is preferably a selective one-way driving device. The second driving device 14 is preferably a box end.

The second wrench 20 includes a first driving device 23 formed at a first end 21 and a second driving device 24 formed at a second end 22. The first driving device 23 is preferably a box head. The second driving device 24 is preferably an open end.

The bar 30 includes a first end 31, a second end 32 and a middle section 33 between the ends 31 and 32. An upper surface 34 of the middle section 33 and lower surfaces 35 of the ends 31 and 32 are substantially in the same plane. The bar 30 includes a first connecting device 36 on the lower surface 35 of the first end 31 and a second connecting device 37 on the lower surface 35 of the second end 32. The first connecting device 36 is preferably a toothed stud defining an annular groove 361 for receiving a C-clip 362. The second connecting device 37 is preferably a toothed stud defining an annular groove 371 for receiving a C-clip 372. The C-clips 362 and 372 include a circular cross-sectional profile.

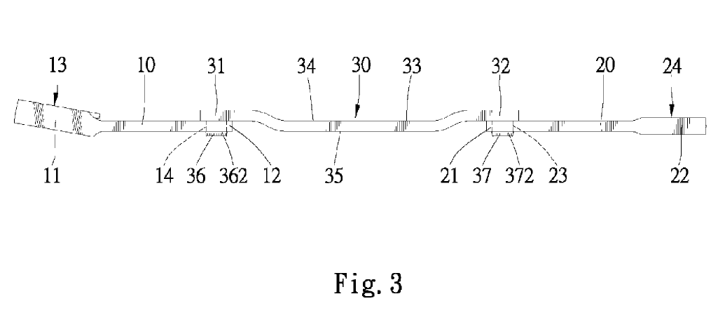

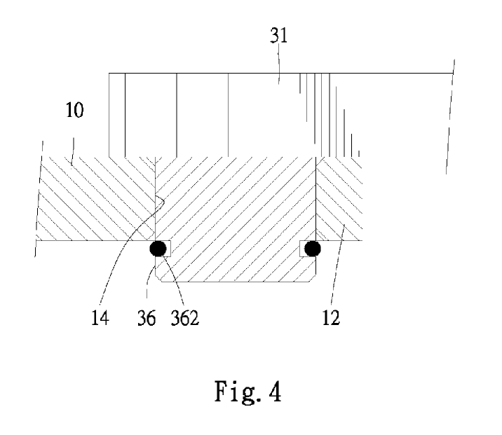

Referring to FIGS. 3 and 4, the C-clip 362 is forced through the second driving device 14 of the first wrench 10 so that the first connecting device 36 of the bar 30 is inserted in the second driving device 14 of the first wrench 10. The C-clip 372 is forced through the first driving device 23 of the second wrench 20 so that the second connecting device 37 of the bar 30 is inserted in the first driving device 23 of the second wrench 20. The C-clips 362 and 372 expand so as to retain the wrenches 10 and 20 on the bar 30.

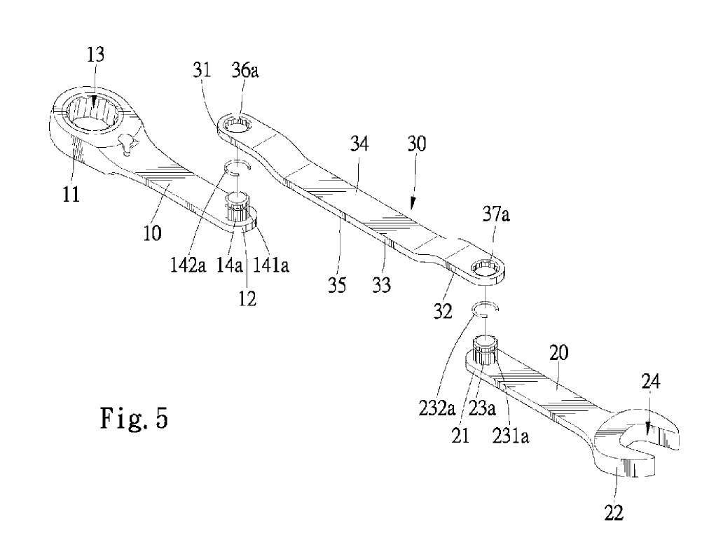

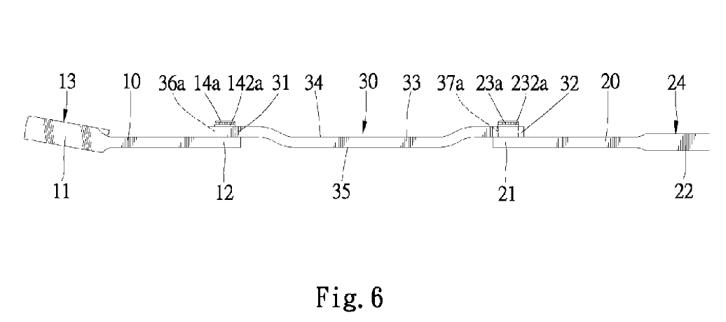

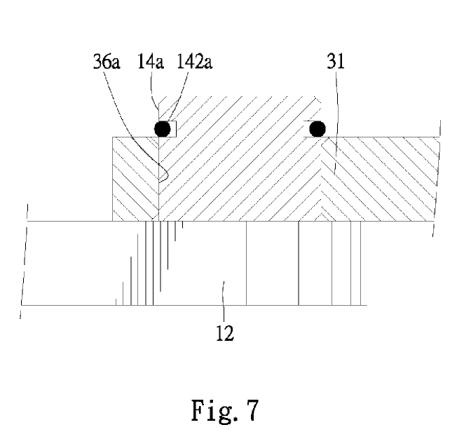

Referring to FIGS. 5 through 7, there is shown a wrench assembly according to a second embodiment of the present invention. The second embodiment is like the first embodiment except a few things. Firstly, the first wrench 10 includes a second driving device 14a instead of the second driving device 14. The second driving device 14a of the first wrench 10 is preferably a toothed stud defining an annular groove 141a for receiving a C-clip 142a. Secondly, the second wrench 20 includes a first driving device 23a instead of the first driving device 23. The first driving device 23a of the second wrench 20 is preferably a toothed stud defining an annular groove 231a for receiving a C-clip 232a. The bar 30 includes two connecting devices 36a and 37a instead of the connecting devices 36 and 37. The connecting devices 36a and 37a are preferably box ends.

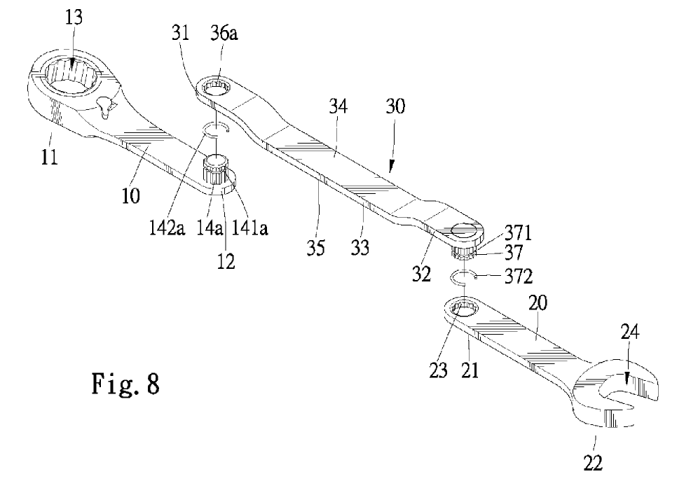

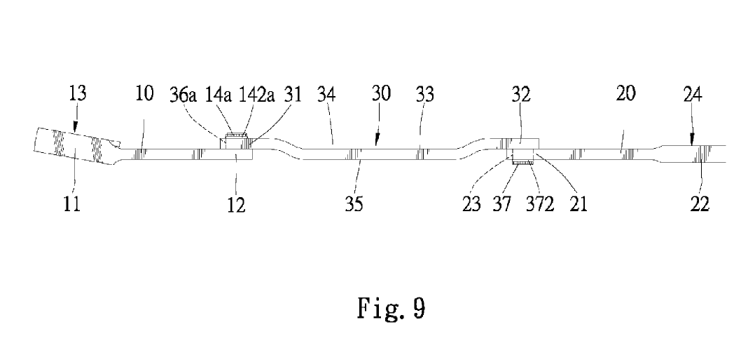

Referring to FIGS. 8 and 9, there is shown a wrench assembly according to a third embodiment of the present invention. The third embodiment is like the first and second embodiments except a few things. Firstly, the first wrench 10 includes a second driving device 14a. Secondly, the second wrench 20 includes a first driving device 23. Thirdly, the bar 30 includes a first connecting device 36a and a second connecting device 37.

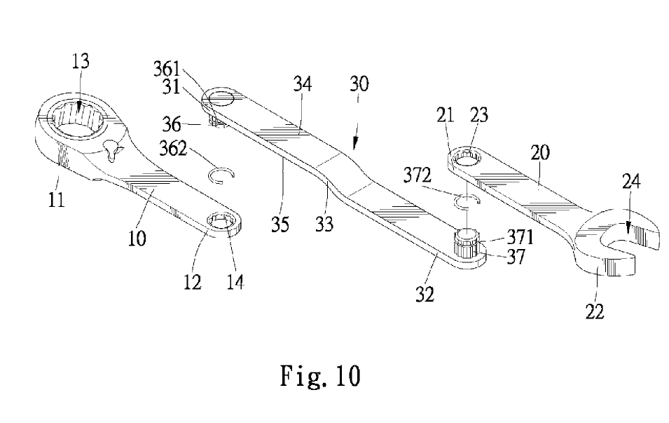

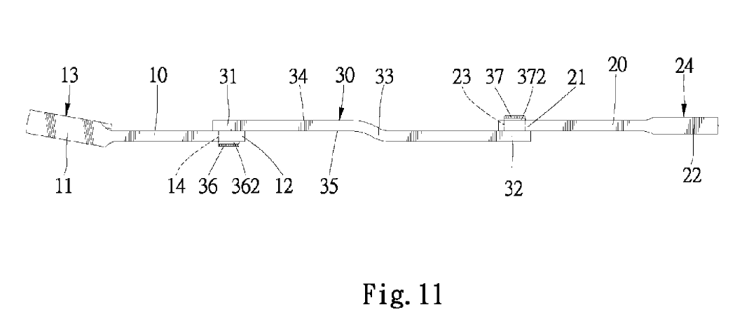

Referring to FIGS. 10 and 11, there is shown a wrench assembly according to a fourth embodiment of the present invention. The fourth embodiment is like the first and second embodiments except a few things. Firstly, the first wrench 10 includes a second driving device 14. Secondly, the second wrench 20 includes a first driving device 23a. Thirdly, the bar 30 includes a first connecting device 36 and a second connecting device 37a.

The wrench assembly of the present invention exhibits several advantages. Firstly, the insertion of the C-clips in the annular grooves ensures adequate connection of the first and second wrenches to the bar. Secondly, the circular cross-sectional profile of the C-clips ensures smooth sliding of the C-clips on the internal faces of the box ends and smooth insertion of the C-clips into the annular grooves. Thirdly, with the interconnection ensured, the first and second wrenches and the bar are thin and easily operable within limited space.

The present invention has been described via the illustration of the embodiments. Those skilled in the art can derive variations from the embodiments without departing from the scope of the present invention. Therefore, the embodiments shall not limit the scope of the present invention defined in the claims.

What is claimed is:

1. A wrench assembly comprising:
a first wrench comprising a first driving device at an end and a second driving device at an opposite end;
a second wrench comprising a first driving device at an end and a second driving device at an opposite end; and
a bar comprising a first connecting device for connection to the second driving device of the first wrench and a second connecting device for connection to the first driving device of the second wrench;
a first C-clip for reinforcing the connection of the first connecting device of the bar to the second driving device of the first wrench; and
a second C-clip for reinforcing the connection of the second connecting device of the bar to the first driving device of the second wrench.

2. The wrench assembly according to claim 1 wherein the first C-clip comprises a circular cross-sectional profile.

3. The wrench assembly according to claim 1 wherein the second C-clip comprises a circular cross-sectional profile.

4. The wrench assembly according to claim 1 wherein the first connecting device of the bar comprises a toothed stud defining an annular groove for receiving the first C-clip, wherein the second driving device of the first wrench comprises a box end for receiving the toothed stud of the bar.

5. The wrench assembly according to claim 1 wherein the second driving device of the first wrench comprises a toothed stud defining an annular groove for receiving the first C-clip, wherein the first connecting device of the bar comprises a box end for receiving the toothed stud of the first wrench.

6. The wrench assembly according to claim 1 wherein the second connecting device of the bar comprises a toothed stud defining an annular groove for receiving the first C-clip, wherein the first driving device of the second wrench comprises a box end for receiving the toothed stud of the bar.

7. The wrench assembly according to claim 1 wherein the first driving device of the second wrench comprises a toothed stud defining an annular groove for receiving the first C-clip, wherein the second connecting device of the bar comprises a box end for receiving the toothed stud of the second wrench.

8. The wrench assembly according to claim 1 wherein the first driving device of the first wrench is a selective one-way driving device.

9. The wrench assembly according to claim 1 wherein the second driving device of the second wrench is an open end.

10. The wrench assembly according to claim 1 wherein the bar comprises a middle section between the first and second connecting devices, wherein the middle section comprises an upper surface coinciding with a lower surface of the first connection device.

11. The wrench assembly according to claim 1 wherein the bar comprises a middle section between the first and second connecting devices, wherein the middle section comprises an upper surface coinciding with a lower surface of the second connection device.

12. The wrench assembly according to claim 1 wherein the bar comprises a middle section between the first and second connecting devices, wherein the middle section comprises an upper surface coinciding with lower surfaces of the first and second connection devices.
